(19) United States
(12) Patent Application Publication
(10) Pub. No.: US 2008/0057375 A1
(43) Pub. Date: Mar. 6, 2008

(54) Fuel cell and fuel supply device for fuel cell

(75) Inventor: Shinichiro Imura, Hyogo (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/896,165

(22) Filed: Aug. 30, 2007

(30) Foreign Application Priority Data
Aug. 30, 2006 (JP) 2006-234287
Aug. 10, 2007 (JP) 2007-209455

(51) Int. Cl. H01M 2/38

(52) U.S. Cl. 429/34

(57) ABSTRACT

A technology is provided for conveniently and easily supplying fuel to a fuel cell while restricting any degradation in the performance of the fuel cell. A fuel supply device for a fuel cell has an attachment unit to which a cellular phone with a DMFC is attachable and a fuel cartridge for storing fuel used in the DMFC. In the fuel supply device, when the DMFC is attached to the attachment unit, a pump sucks up the fuel from the fuel cartridge and supplies the fuel to a fuel storage unit. Also, supplying the fuel to the fuel storage unit pushes liquid waste out of the fuel storage unit to collect the liquid waste into a liquid waste cartridge.

### CROSS-REFERENCE TO RELATED APPLICATIONS

This application is based upon and claims the benefit of priority from the prior Japanese Patent Applications No. 2006-234287, filed Aug. 30, 2006, and Japanese Patent Application No. 2007-209455, filed Aug. 10, 2007, the entire contents of which are incorporated herein by reference.

### BACKGROUND OF THE INVENTION

1. Field of the Invention

The present invention relates to a technology for supplying fuel to a fuel cell.

2. Description of the Related Art

Fuel cells are devices for generating electrical energy from hydrogen and oxygen, and are capable of providing high efficiency power generation. One of the main features of a fuel cell is that the electrical power is generated through direct power generation, which is in contrast to conventional power generation methods where electrical power is generated via thermal or kinetic energy processes. Therefore, in a fuel cell, high efficiency power generation can be expected even in small-scale systems. Furthermore, a fuel cell is considered to be very environmentally friendly as it emits lesser amounts of nitrogen-based compounds, and the like, and generates less noise and vibration than conventional power generation methods. Since fuel cells can thus make effective use of the chemical energy of fuel, and have environmentally friendly characteristics, they are expected to serve as the energy supply systems of the 21st century. Fuel cells are attracting considerable attention as promising novel generation systems in a variety of applications ranging from large-scale power generation to small-scale power generation, including space technologies, automobiles, and portable devices. Thus, the technological development of the fuel cell for practical use is well under way.

Of the various types of fuel cells available, a polymer electrolyte fuel cell is characterized by lower operating temperatures and higher output densities when compared to the other types of fuel cells. In particular, a direct methanol fuel cell (DMFC) has received attention in recent years as a promising type of polymer electrolyte fuel cell. In a DMFC, a methanol aqueous solution serving as a fuel is directly supplied to an anode without first being reformed in order to obtain electrical power through an electrochemical reaction between the methanol aqueous solution and oxygen. This electrochemical reaction yields reaction products such as carbon dioxide, which is emitted from the anode, and water, which is emitted from the cathode. Since the methanol aqueous solution has a higher energy per unit volume than hydrogen and is more suitable for storage with less risk of explosion when compared with hydrogen, it is expected that the methanol aqueous solution will be used as the power source in automobiles and portable devices (such as cellular phones, notebook personal computers, PDAs, MP3 players, digital cameras, and electronic dictionaries (and electronic books)), and the like.

A DMFC is divided into an active type in which fuel is forcedly supplied to the anode using auxiliary equipment such as a pump, and a passive type in which fuel and air are supplied by convection, a concentration gradient, or the like without the use of auxiliary equipment such as the pump. Of the two types, the passive type has a simple structure that does not require auxiliary equipment such as the pump and hence is suitable for miniaturization.

For example, when the passive type of fuel cell is used as the power source of a portable device, a device for supplying fuel to the fuel cell is already known.

In recent years, a polymer electrolyte fuel cell (PEFC) which generates electrical power by use of a gaseous fuel has been miniaturized and the technology required for using the PEFC as the power source of a portable device has been developed. In the case of a PEFC, either methanol reformation or the use of a hydrogen storage alloy has been established as the usual means for supplying a fuel gas to the PEFC.

In a DMFC, by-products such as unreacted water which is not used in the reaction and formic acid generated by the reaction of methanol (or another fuel) is accumulated at the anode as liquid waste. The accumulation of by-products causes degradation in the performance of the fuel cell in areas such as fuel efficiency, output power, and durability. In a conventional fuel supply device, however, the liquid waste remains accumulated in a fuel storage unit of the DMFC so that there is a problem in that the performance of the fuel cell is degraded, as described above. With regard to the PEFC, there are problems in that the poisoning of the catalytic metal causes degradation in the performance of the fuel cell and also causes degradation in the hydrogen storage performance of the hydrogen storage alloy.

### SUMMARY OF THE INVENTION

The present invention has been developed in view of the aforementioned problems and a general purpose thereof is to provide a technology for conveniently and easily supplying fuel to a fuel cell while restricting any degradation in the performance of the fuel cell.

One embodiment of the present invention is a fuel supply device for a fuel cell which can supply fuel to the fuel cell, comprising: an attachment unit to which the fuel cell is attachable; a fuel cartridge which houses fuel used in the fuel cell; a residual material collecting means which collects residual materials remaining in the fuel cell when the fuel cell is attached to the attachment unit; and a fuel supply unit which supplies the fuel from the fuel cartridge to a fuel storage unit of the fuel cell when the fuel cell is attached to the attachment unit.

In the above embodiment, the residual material collecting means may collect liquid waste as residual materials.

The phrase “the fuel cell is attached” should be understood to include both directly attaching the fuel cell to the attachment unit and attaching a portable device, in which the fuel cell is installed, to the attachment unit.

According to the present embodiment, not only is fuel conveniently and easily supplied to the fuel cell but it is also possible to restrict any degradation in the performance of the fuel cell by collecting the liquid waste remaining in the fuel storage unit of the fuel cell.

In the foregoing embodiment, the residual material collecting means may collect the liquid waste by supplying fuel to the fuel storage unit and pushing out the liquid waste remaining in the fuel storage unit. Accordingly, the fuel supply unit may supply a predetermined amount of fuel to the fuel storage unit after the fuel storage unit becomes full of fuel in order to push the liquid waste remaining in the fuel storage unit out.

According to the present embodiment, it is possible to both collect the liquid waste from the fuel storage unit and supply fuel to the fuel storage unit concurrently.

In the foregoing embodiment, the fuel supply device may further comprises a detergent cartridge which houses detergent, a detergent supply unit which supplies the detergent to the fuel storage unit to wash an anode electrode of the fuel cell, and a detergent collection unit which collects the detergent from the fuel storage unit. Accordingly, the fuel supply device may further comprise a switching unit which switches between the fuel supply to the fuel storage unit and the liquid waste collection, and the detergent supply to the fuel storage unit and the detergent collection.

According to the present embodiment, it is possible to easily carry out maintenance on the fuel cell in addition to the fuel supply to the fuel cell and the liquid waste collection.

Another embodiment of the present invention is a fuel cell which is attachable to the attachment unit of the fuel supply device for the fuel cell according to any of the foregoing embodiments, comprising: a fuel supply port through which the fuel supply unit supplies fuel to the fuel storage unit for storing fuel; and a liquid waste discharge port through which the liquid waste is discharged.

In the foregoing embodiment, the residual material collecting means may collect by-products as residual materials. The residual material collecting means may supply a fluid other than the fuel to a fuel charge unit in which fuel supplied from the fuel storage unit is charged, and collect the by-product remaining in the fuel charge unit and the anode electrode by pushing out the by-product. The residual material collecting means may collect the by-product remaining in a fuel charge unit in which fuel supplied from the fuel storage unit is charged and the anode electrode by sucking up the by-product. The residual material collecting means may collect by-product remaining in the fuel storage unit or a reforming unit in which the fuel supplied from the fuel storage unit is reformed by supplying a fluid other than the fuel to the fuel storage unit or the reforming unit and by pushing out the by-product. The residual material collecting means may collect by-product remaining in the fuel storage unit or a reforming unit in which the fuel supplied from the fuel storage unit is reformed by sucking up the by-product. Accordingly, the fuel supply device may further comprise a unit for applying a load on the fuel cell to which a fluid other than the fuel is supplied in a state where the fuel cell is attached to the attachment unit and the fluid is supplied to the fuel cell.

Yet another embodiment of the present invention is a fuel cell. The fuel cell which is attachable to the attachment unit of the foregoing fuel supply device for the fuel cell according to any of the foregoing embodiments, comprising: a fuel storage unit connection port which connects to the fuel storage unit through which fuel or a fluid other than the fuel is supplied and any by-products remaining in the fuel storage unit are discharged; and a fuel charge unit connection port connecting to a fuel charge unit in which fuel supplied from the fuel storage unit is charged into in order to supply the fuel or the fluid other than the fuel and discharge any by-products remaining in the fuel charge unit or at the anode electrode.

It should be appreciated that any combination of each of the foregoing embodiments should be understood to be included in the scope of the invention for which protection is sought by the filing of this patent application.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a cellular phone according to a first embodiment and the structure of a DMFC installed in the cellular phone;

FIG. 2 shows the outer appearances of the cellular phone and a fuel supply device for a fuel cell according to the first embodiment;

FIG. 3 shows the structure of the fuel supply device for the fuel cell according to the first embodiment;

FIG. 4 shows the structure of a fuel supply device for a fuel cell according to a second embodiment;

FIG. 5 shows a cellular phone according to a third embodiment and the structure of a PEFC installed in the cellular phone;

FIG. 6 shows the outer appearances of the cellular phone and a fuel supply device for a fuel cell according to the third embodiment;

FIG. 7 shows the structure of the fuel supply device for the fuel cell according to the third embodiment;

FIG. 8 shows a cellular phone according to a fourth embodiment and the structure of a PEFC installed in the cellular phone; and

FIG. 9 shows the structure of a fuel supply device for a fuel cell according to the fourth embodiment.

### DETAILED DESCRIPTION OF THE INVENTION

The invention will now be described by reference to the preferred embodiments. This does not intend to limit the scope of the present invention, but to exemplify the invention.

### First Embodiment

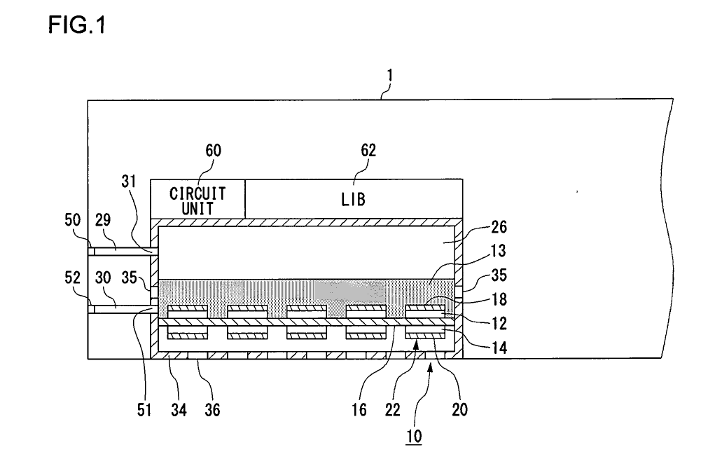

FIG. 1 shows a cellular phone 1 according to the first embodiment and the structure of a DMFC 10 installed in the cellular phone 1.

The DMFC 10 is provided with anode electrodes 12 to which a methanol aqueous solution or pure methanol (hereinafter described as “fuel”) is supplied by capillary action, cathode electrodes 14 to which air is supplied, and a polymer electrolyte 16 sandwiched between the anode electrodes 12 and the cathode electrodes 14. The DMFC 10 generates electrical power by an electrochemical reaction between methanol in the fuel and oxygen in the air. In each cell 22, the anode electrode 12 is provided with a charge collector 18 and the cathode electrode 14 is provided with a charge collector 20. By connecting each of the charge collectors 18 and 20 with wiring (not shown), a plurality of cells 22 can be connected in series.

A wicking material 13 is provided around the anode electrodes 12. The wicking material 13 has the functions of wicking the fuel and supplying the fuel to the anode electrodes 12 through the charge collectors 18. A fuel storage unit 26 in which the fuel is stored is provided adjacent to the wicking material 13. The wicking material 13 wicks the fuel stored in the fuel storage unit 26 as required. Gas-liquid separation filters 35 are provided on the sides of the wicking material 13 in a case 34 on the side of the fuel storage unit 26. Gas such as carbon dioxide generated at the anode electrodes 12 is discharged through the gas-liquid separation filters 35.

A fuel supply port 31 is provided in the case 34 forming the fuel storage unit 26. The fuel storage unit 26 is connected to a fuel suction unit 50 via the fuel supply port 31 and a pipe 29. The fuel suction unit 50 is provided with a check valve. A discharge port 51 is provided in the case 34 in the vicinity of the anode electrode 12, and the discharge port 51 is connected to a liquid waste discharge unit 52 via a pipe 30.

Conversely, air is supplied to the cathode electrodes 14 by taking advantage of the air flow that naturally occurs from an air intake port 36 provided in the case 34 on the side of the cathode electrodes 14. In the present embodiment, the structure of the anode electrode 12 and the cathode electrode 14 is not limited as long as a catalyst layer having the catalytic function of producing H⁺ from methanol exists at the anode electrode 12 and a catalyst layer having the catalytic function of producing water from H⁺ and oxygen exists at the cathode electrode 14. The catalyst layer at the anode electrode 12 and at the cathode electrode 14 may be formed, for example, on an electrode substrate such as carbon paper.

Electrical power obtained from the DMFC 10 is converted into a predetermined voltage by a circuit unit 60 and is then used for charging a LIB (lithium ion secondary battery) 62 or is used as a power source of a cellular phone 1 as necessary.

The amount of fuel remaining in the fuel storage unit 26 is detected by a remaining amount detection unit such as a water level sensor. Data relating to the amount of remaining fuel detected by the remaining amount detection unit is sent to a fuel supply device for a fuel cell (to be described later) by a radio communication unit (not shown) such as infrared-ray communication or the like.

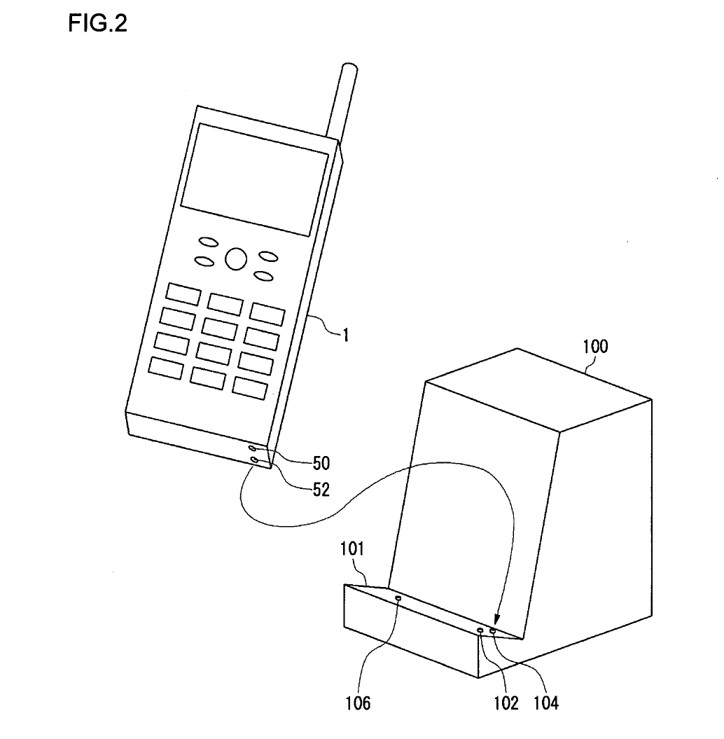

FIG. 2 shows the outer appearances of the cellular phone 1 and a fuel supply device 100 for a fuel cell according to the first embodiment. The fuel supply device 100 for the fuel cell has an attachment unit 101 to which the cellular phone 1 can be attached. In the bottom of the attachment unit 101, a fuel supply unit 102 and a liquid waste receiving unit 104 which are connectable to the fuel suction unit 50 and the liquid waste discharge unit 52 respectively, (which are provided in the bottom of the cellular phone 1) are provided.

Attaching the cellular phone 1 to the attachment unit 101 connects the fuel suction unit 50 provided in the cellular phone 1 to the fuel supply unit 102 provided in the fuel supply device 100 for the fuel cell, and also connects the liquid waste discharge unit 52 provided in the cellular phone 1 to the liquid waste receiving unit 104 provided in the fuel supply device 100 for the fuel cell.

When the fuel supply unit 102 is connected to the fuel suction unit 50, the check valve provided in the fuel suction unit 50 opens to make it possible to charge liquid such as the fuel from the fuel supply unit 102 into the fuel suction unit 50. When the liquid waste receiving unit 104 is connected to the liquid waste discharge unit 52, a check valve provided in the liquid waste discharge unit 52 opens to discharge liquid such as the liquid waste from the liquid waste discharge unit 52 into the liquid waste receiving unit 104.

A pin 106 is provided in the bottom of the attachment unit 101. The pin 106 protrudes above the bottom of the attachment unit 101 by the elastic force of a spring or the like when the cellular phone 1 is not attached thereto, and is pushed into the fuel supply device 100 for the fuel cell by a pushing motion. When the pin 106 is pushed into the fuel supply device 100 for the fuel cell, it is detected that the cellular phone 1 is attached to the attachment unit 101.

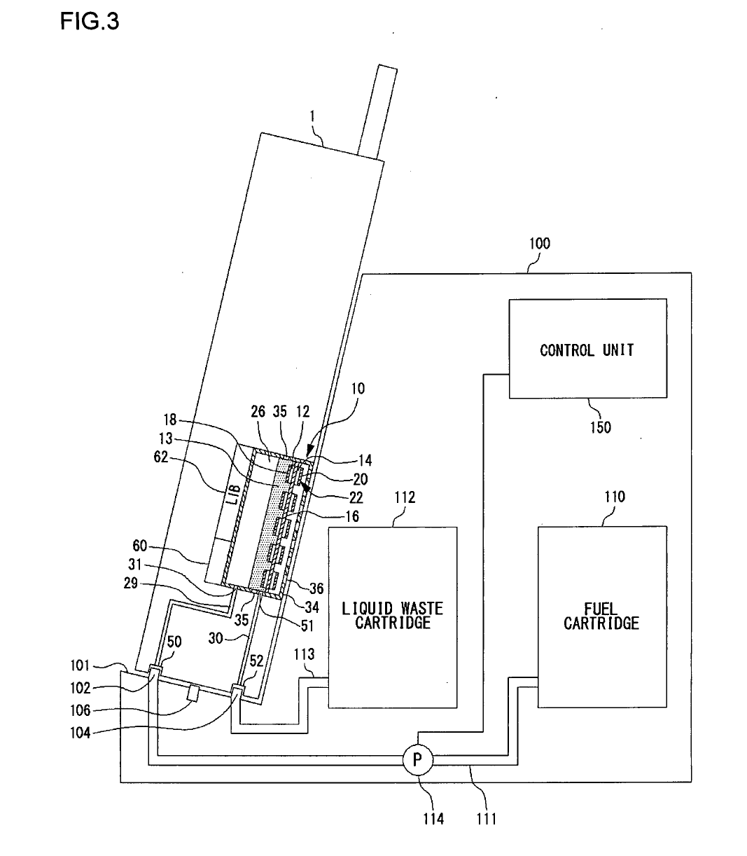

FIG. 3 shows the structure of the fuel supply device 100 for the fuel cell. The fuel supply device 100 for the fuel cell includes the attachment unit 101 with the fuel supply unit 102, the liquid waste receiving unit 104, and the pin 106 to make the cellular phone 1 attachable thereto.

The fuel supply device 100 for the fuel cell is also provided with a fuel cartridge 110, a liquid waste cartridge 112, a pump 114, and a control unit 150. The fuel cartridge 110 and the liquid waste cartridge 112 are detachable so as to be replaceable as necessary.

The fuel cartridge 110 is connected to the fuel supply unit 10 via a pipe 111. The pipe 111 includes the pump 114 that is provided as a fuel delivery unit. The pump 114 sucks up the fuel from the fuel cartridge 110 and supplies the fuel to the fuel storage unit 26 of the DMFC 10 installed in the cellular phone 1 via the fuel supply unit 102 and the fuel suction unit 50. The control unit 150 (to be described later) controls the fuel supply operation of the pump 114.

Conversely, the liquid waste cartridge 112 is connected to the liquid waste receiving unit 104 via a pipe 113. When the pump 114 supplies the fuel to the fuel storage unit 26 of the DMFC 10, liquid waste is pushed out of the fuel storage unit 26 through the discharge port 51. The liquid waste discharged from the fuel storage unit 26 is collected in the liquid waste cartridge 112 via the liquid waste discharge unit 52 and the liquid waste receiving unit 104.

Data relating to the amount of fuel remaining in the fuel storage unit 26 which is received by a wired communication unit (not shown) with a connector and the like, or a wireless communication unit (not shown) such as infrared-ray communication corresponding to the cellular phone 1, or the like is inputted to the control unit 150. The control unit 150 calculates the amount of fuel to be supplied to the fuel storage unit 26 based on the capacity of the fuel storage unit 26 and data received regarding the amount of remaining fuel. The control unit 150 activates the pump 114 to supply the calculated amount of fuel to the fuel storage unit 26 and then to further supply only a predetermined amount of fuel, or supply the fuel for only a predetermined period of time to the fuel storage unit 26.

The supply of fuel to the fuel cell by the fuel supply device 100 for the fuel cell and the operation of the liquid waste collection will now be described.

When a user attaches the cellular phone 1 to the attachment unit 101, the fuel suction unit 50 provided in the cellular phone 1 is connected to the fuel supply unit 102 provided in the fuel supply device 100 for the fuel cell and the liquid waste discharge unit 52 provided in the cellular phone 1 is connected to the liquid waste receiving unit 104 provided in the fuel supply device 100 for the fuel cell. At this time, the attachment of the cellular phone 1 is detected by the pushing of the pin 106 into the fuel supply device 100, and a detection signal is sent to the control unit 150. Also at this time, the control unit 150 fixes the cellular phone 1 in place by a lock mechanism (not shown) or the like so that the cellular phone 1 is not able to be detached from the attachment unit 101.

Then, a control signal from the control unit 150 activates the pump 114 to suck the fuel out of the fuel cartridge 110 and supplies the fuel to the fuel storage unit 26. The control unit 150 detects that the fuel storage unit 26 becomes full of the fuel based on data relating to the amount of fuel remaining in the fuel storage unit 26, and then makes the pump 114 supply the fuel storage unit 26 with only a predetermined amount of fuel, or with fuel for only a predetermined period of time. Accordingly, not only is it possible to safely and conveniently store fuel in which a percentage of the impurity content has been restricted in the fuel storage unit 26, but it is also possible to restrict any by-products from inhibiting the electrochemical reaction in each cell, and hence it is also possible to restrict any degradation in the electrical power generation performance of the DMFC 10 by means of sufficiently expelling the liquid waste remaining in the fuel storage unit 26.

The aforementioned lock mechanism is then released so that the cellular phone 1 can be detached from the attachment unit 101. Information relating to whether or not the lock mechanism is working or whether or not fuel is being supplied to the cellular phone 1 may be sent to the cellular phone 1 from the control unit 150 using the radio communication unit, and the information relating to the operation of the lock mechanism and the like may be displayed on a display unit of the cellular phone 1 by use of color, letters, or the like.

In the present embodiment, fuel supplied to the fuel storage unit 26 by the pump 114 pushes the liquid waste accumulated in the fuel storage unit 26 out of the fuel storage unit 26 to allow for the collection of the liquid waste in the liquid waste cartridge 112. However, the fuel supply device 100 for the fuel cell may be further provided with a pump for sucking the liquid waste out of the fuel storage unit 26.

The fuel supply device 100 for the fuel cell according to the present embodiment can be miniaturized by limiting its function and is suitably available as a device by which users are able to replenish the DMFC 10 of the cellular phone 1 with fuel themselves.

### Second Embodiment

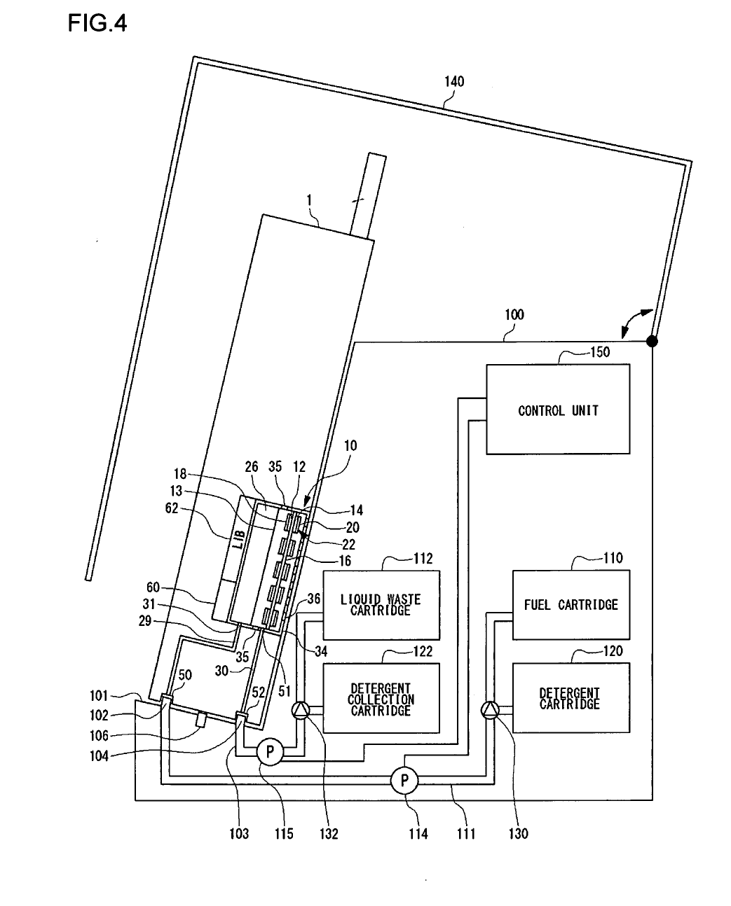

FIG. 4 shows the structure of a fuel supply device 100 for a fuel cell according to a second embodiment. The fuel supply device 100 according to the present embodiment further includes a detergent cartridge 120, a detergent collection cartridge 122, and a pump 115 in addition to the structures of the first embodiment.

At least one motor-operated three-way valve 130 is provided in the pipe 111 so that a suction target of the pump 114 can be switched between the fuel cartridge 110 and at least one detergent cartridge 120. The control unit 150 controls the operation of the motor-operated three-way valve 130. The detergent contained in the detergent cartridge 120 may include water, dilute sulfuric acid, hydrogen peroxide solution, nitric acid (0.5 M or less), and the like. In the case of a detergent that contains water, by heating the detergent to, for example, approximately 80 degrees centigrade, the washing effect of the detergent can be improved. Therefore, it is more preferable that a heating unit such as a heater be provided for heating the detergent cartridge 120 of the fuel supply device 100 for the fuel cell.

The pipe 103 is provided with a motor-operated three-way valve 132 so that a delivery target of liquid of the pump 115 can be switched between the liquid waste cartridge 112 and the detergent collection cartridge 122. The control unit 150 controls the operation of the motor-operated three-way valve 132.

The supply of fuel to the fuel cell, the liquid waste collection, and the maintenance operation of the fuel cell by the fuel supply device 100 for the fuel cell in this embodiment will now be described. The fuel supply device 100 for the fuel cell can be switched among various operation modes such as (a) fuel replenishment only, (b) fuel replenishment after collecting liquid waste, (c) fuel replenishment after washing, and the like. Accordingly, a user can set the fuel supply device 100 for the fuel cell to a desired operation mode by the use of a display unit and an operation unit of the cellular phone 1. The following description describes a case where the user has selected mode (c) fuel replenishment after washing as an example.

First, when the user attaches the cellular phone 1 to the attachment unit 101, the fuel suction unit 50 provided in the cellular phone 1 is connected to the fuel supply unit 102 provided in the fuel supply device 100 for the fuel cell, and the liquid waste discharge unit 52 provided in the cellular phone 1 is connected to the liquid waste receiving unit 104 provided in the fuel supply device 100 for the fuel cell. At this time, the attachment of the cellular phone 1 is detected by pushing the pin 106 in, and a detection signal is sent to the control unit 150. Also at this time, the control unit 150 fixes the cellular phone 1 in place by a lock mechanism (not shown) or the like so that the cellular phone 1 is not able to be detached from the attachment unit 101.

Then, the control unit 150 switches the suction target of the pump 114 to the detergent cartridge 120 using the motor-operated three-way valve 130, and switches the delivery target of the pump 115 to the detergent collection cartridge 122 using the motor-operated three-way valve 132. After that, the pump 114 is activated to suck the detergent from the detergent cartridge 120 and the detergent is then supplied to the fuel storage unit 26. The detergent washes the fuel storage unit 26, the anode electrodes 12, and the wicking material 13. The detergent supplied to the fuel storage unit 26 is discharged from the fuel storage unit 26 through the discharge port 51 and is then collected in the detergent collection cartridge 122 by activation of the pump 115.

Then, the control unit 150 switches the suction target of the pump 114 to the fuel cartridge 110 using the motor-operated three-way valve 130, and switches the delivery target of the pump 115 to the liquid waste cartridge 112 using the motor-operated three-way valve 132. After that, a control signal from the control unit 150 activates the pump 114 to suck the fuel from the fuel cartridge 110 and the fuel is supplied to the fuel storage unit 26. The control unit 150 detects that the fuel storage unit 26 becomes full of fuel based on data relating to the amount of fuel remaining in the fuel storage unit 26, and then makes the pump 114 supply the fuel storage unit 26 with only a predetermined amount of fuel, or with fuel for only a predetermined period of time. Accordingly, not only is it possible to safely and conveniently store fuel in which a percentage of the impurity content has been restricted in the fuel storage unit 26, but it is also possible to restrict any by-products from inhibiting the electrochemical reaction in each cell and hence it is also possible to restrict any degradation in the electrical power generation performance of the DMFC 10 by means of sufficiently expelling the liquid waste remaining in the fuel storage unit 26.

Then, the aforementioned lock mechanism is released so that the cellular phone 1 can be detached from the attachment unit 101. Information relating to whether or not the lock mechanism is working, whether or not the fuel is being supplied to the cellular phone 1, and whether or not washing is being carried out may be sent to the cellular phone 1 from the control unit 150 using the radio communication unit, and the information relating to the operation of the lock mechanism and the like may be displayed on the display unit of the cellular phone 1 by use of color, letters, or the like.

As shown in FIG. 4, it is preferable to provide a cover 140 for covering the attachment unit 101 and the attached cellular phone 1. Since the cover 140 prevents the fuel of the fuel cell, the liquid waste, the detergent, and the like from being scattered, it is possible to increase the safety of the fuel supply device 100 for the fuel cell. It is also preferable that a lock mechanism is provided to open and close the cover 140 and the cover 140 is locked while the fuel cell at least is being washed.

The fuel supply device 100 for the fuel cell according to the second embodiment is a multifunction device which has the function of not only supplying the fuel to the fuel cell, but also washing the electrodes of the fuel cell. Therefore, the fuel supply device 100 for the fuel cell is intended for commercial use by being set up in a convenience store, a cellular phone shop, and the like.

### Third Embodiment

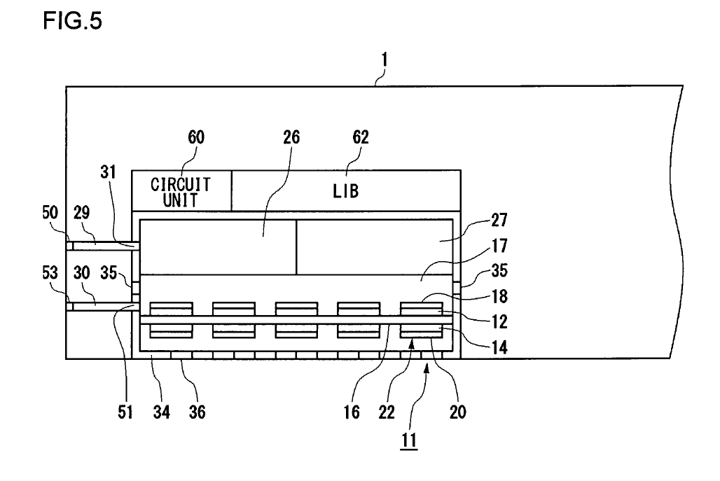

In each of the foregoing embodiments, a DMFC was used as the fuel cell but it should be appreciated that the fuel cell is not limited to this type of fuel cell only. The fuel cell may, for example, be a polymer electrolyte fuel cell (PEFC) which generates electrical power by use of gaseous fuel. FIG. 5 shows a cellular phone 1 according to a third embodiment and the structure of a PEFC 11 installed in the cellular phone 1.

In the PEFC 11, hydrogen is supplied to the anode electrodes 12 and electrical power is generated by an electrochemical reaction between the hydrogen and oxygen in the air. A fuel charge unit 17 in which fuel containing the hydrogen is charged is provided on the side of the anode electrodes 12. The PEFC 11 is provided with a reforming unit 27 in addition to the fuel storage unit 26 described in the first embodiment. In the reforming unit 27, methanol supplied from the fuel storage unit 26 is reformed by a steam reforming method using vapor phase contact to generate hydrogen. In the reforming unit 27, CO₂ and CO are generated as by-product. Fuel gas containing the hydrogen which is generated in the reforming unit 27 is supplied to the fuel charge unit 17. In the PEFC 11, an outside connection port 53 is provided instead of the liquid waste discharge unit 52 described in the first embodiment. There are cases where the by-products occurring in the reforming unit 27 are accumulated in the fuel storage unit 26 and hence it is necessary to remove the by-product from the fuel storage unit 26.

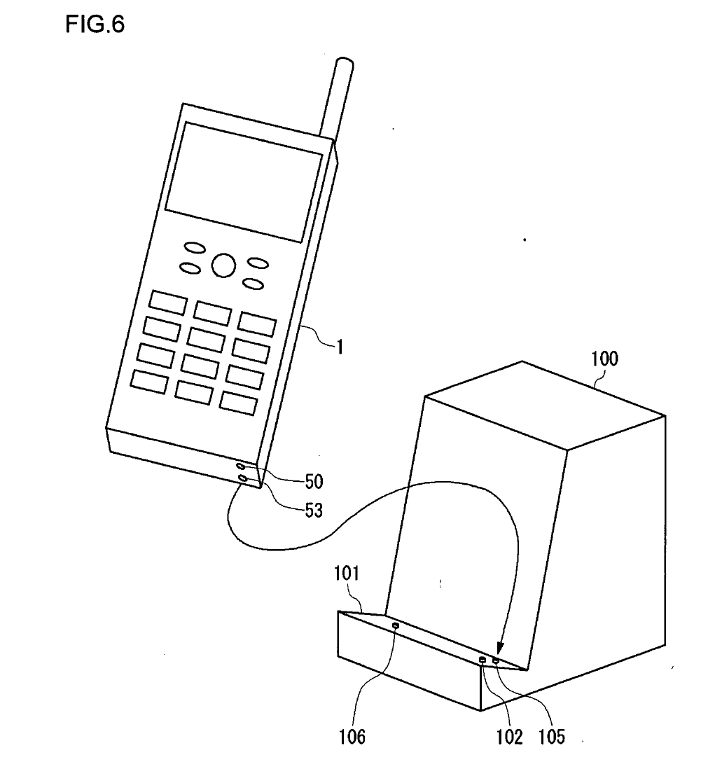

FIG. 6 shows the outer appearances of the cellular phone 1 and a fuel supply device 100 for a fuel cell according to a third embodiment. The fuel supply device 100 for the fuel cell has an attachment unit 101 to which the cellular phone 1 is attachable. A fuel supply unit 102 and a connection unit 105 which are connectable to a fuel suction unit 50 and an outside connection port 53 provided in the bottom of the cellular phone 1, respectively, are provided in the bottom of the attachment unit 101.

When the cellular phone 1 is attached to the attachment unit 101, the fuel suction unit 50 provided in the cellular phone 1 is connected to the fuel supply unit provided in the fuel supply device 100 for the fuel cell, and the outside connection port 53 provided in the cellular phone 1 is connected to the connection unit 105 provided in the fuel supply device 100 for the fuel cell.

When the fuel supply unit 102 is connected to the fuel suction unit 50, a check valve provided in the fuel suction unit 50 opens to make it possible to deliver a gas such as the fuel or liquid from the fuel supply unit 102 into the fuel suction unit 50. When the connection unit 105 is connected to the outside connection port 53, a check valve provided in the outside connection port 53 opens to connect the outside connection port 53 to the connection unit 105.

A pin 106 is provided in the bottom of the attachment unit 101. The pin 106 protrudes above the bottom of the attachment unit 101 by the elastic force of a spring or the like when the cellular phone 1 is not attached, and is pushed into the fuel supply device 100 for the fuel cell by a pushing motion. When the pin 106 is pushed into the fuel supply device 100 for the fuel cell, it is detected that the cellular phone 1 is attached to the attachment unit 101.

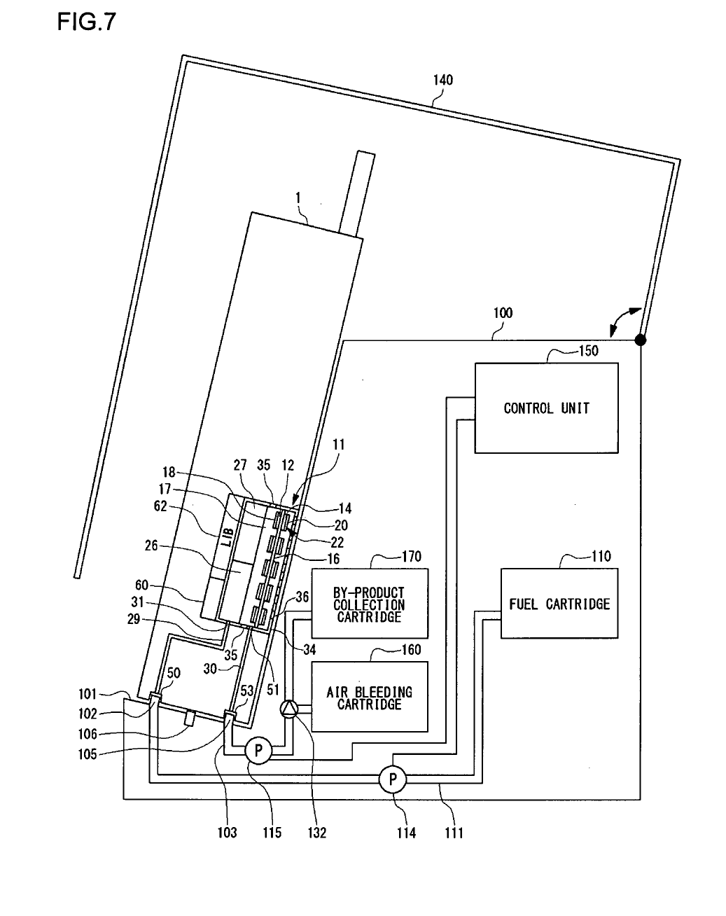

FIG. 7 shows the structure of the fuel supply device 100 for the fuel cell according to the third embodiment. As described above, the fuel supply device 100 for the fuel cell includes the attachment unit 101 in which the fuel supply unit 102, the connection unit 105, and the pin 106 are provided so that the cellular phone 1 is attachable thereto.

The fuel supply device 100 for the fuel cell according to this embodiment is provided with a fuel cartridge 110, an air bleeding cartridge 160, a by-product collection cartridge 170, a pump 114, a pump 115, and a control unit 150. The fuel cartridge 110, the air bleeding cartridge 160, and the by-product collection cartridge 170 are detachable and capable of being replaced as necessary. A hydrogen gas (air bleeding gas) containing oxygen in the range of 4 to 6 wt % is charged into the air bleeding cartridge 160.

The fuel cartridge 110 is connected to the fuel supply unit 102 via a pipe 111. The pipe 111 includes the pump 114 that is provided therein as a fuel delivery unit. The pump 114 sucks up the fuel from the fuel cartridge 110 and supplies the fuel to the fuel storage unit 26 of the PEFC 11 installed in the cellular phone 1 through the fuel supply unit 102 and the fuel suction unit 50. The control unit 150 controls the fuel supply operation of the pump 114.

The pipe 103 is provided with a motor-operated three-way valve 132. By switching the motor-operated three-way valve 132, the fuel supply device 100 for the fuel cell can be switched between a mode of supplying the air bleeding gas contained in the air bleeding cartridge 160 to the anode electrodes 12 of the PEFC 11 and a mode of sucking out any by-products occurring in the PEFC 11 by the pump 115 and collecting the by-products to the by-product collection cartridge 170. The control unit 150 controls the operation of the motor-operated three-way valve 132.

The supply of fuel to the fuel cell, the by-product collection, and the maintenance operation of the fuel cell by the fuel supply device 100 for the fuel cell in this embodiment will now be described. The fuel supply device 100 for the fuel cell can be switched among various operation modes such as (a) fuel replenishment only, (b) fuel replenishment after collecting any by-products, (c) fuel replenishment after air bleeding, and the like. Accordingly, a user can set the fuel supply device 100 for the fuel cell to a desired operation mode by the use of a display unit and an operation unit included in the cellular phone 1. The following description describes a case where the user has selected mode (c) fuel replenishment after air bleeding as an example.

First, when the user attaches the cellular phone 1 to the attachment unit 101, the fuel suction unit 50 provided in the cellular phone 1 is connected to the fuel supply unit 102 provided in the fuel supply device 100 for the fuel cell, and the outside connection port 53 provided in the cellular phone 1 is connected to the connection unit 105 provided in the fuel supply device 100 for the fuel cell. At this time the attachment of the cellular phone 1 is detected by pushing the pin 106 in, and a detection signal is sent to the control unit 150. Also at this time, the control unit 150 fixes the cellular phone 1 in place by a lock mechanism (not shown) or the like so that the cellular phone 1 is not able to be detached from the attachment unit 101.

Then, the control unit 150 switches the motor-operated three-way valve 132 so that the air bleeding gas contained in the air bleeding cartridge 160 can be supplied to the anode electrodes 12 of the PEFC 11 using the pump 115. After that, the pump 115 is activated and the air bleeding gas contained in the air bleeding cartridge 160 is supplied to the anode electrodes 12 of the PEFC 11. Under this condition, a load is applied to the PEFC 11 so that a minute current passes through the anode electrodes 12 and air bleeding is carried out. Since air bleeding removes CO from poisoned catalyst particles, it is possible to recover catalytic activity. As the load in this case, for example, a connection terminal to which the PEFC 11 is connectable is provided in the attachment unit 101, and when the cellular phone 1 is attached to the fuel supply device 100 for the fuel cell, it is preferable that the load occurs due to the electric connection between the fuel supply device 100 for the fuel cell and the PEFC 11.

Then, the application of the load to the PEFC 11 is halted, and the control unit 150 switches the motor-operated three-way valve 132 so that any by-products occurring in the PEFC 11 are sucked out by the pump 115 and can be collected in the by-product collection cartridge 170. By activation of the pump 115, any by-products such as CO is removed from the PEFC 11 and collected in the by-product collection cartridge 170.

Then, only a predetermined amount of fuel is supplied, or fuel is supplied only for a predetermined period of time to the fuel storage unit 26 using the pump 114. The fuel may be supplied to the fuel storage unit 26 before the foregoing air bleeding. Alternatively, fuel may be supplied to the fuel storage unit 26 concurrently with the air bleeding or collection of any by-products.

According to the operation described above, since any by-products which inhibit catalytic activity are collected, it is possible to restrict any degradation in the performance of the electrical power generation of the PEFC 11, and in addition to that, fuel is also supplied to the fuel storage unit 26.

The air bleeding gas is supplied to the fuel charge unit 17 in the present embodiment, and fluid other than the fuel may be supplied to the fuel charge unit 17 instead of the air bleeding gas and any by-products remaining in the fuel charge unit 17 and at the anode electrodes 12 may be collected into the by-product collection cartridge 170 by pushing the by-products out. Alternatively, instead of supplying the fluid, a pump or the like may suck up any by-products remaining in the fuel charge unit 17 and at the anode electrodes 12 out in order to collect them.

### Fourth Embodiment

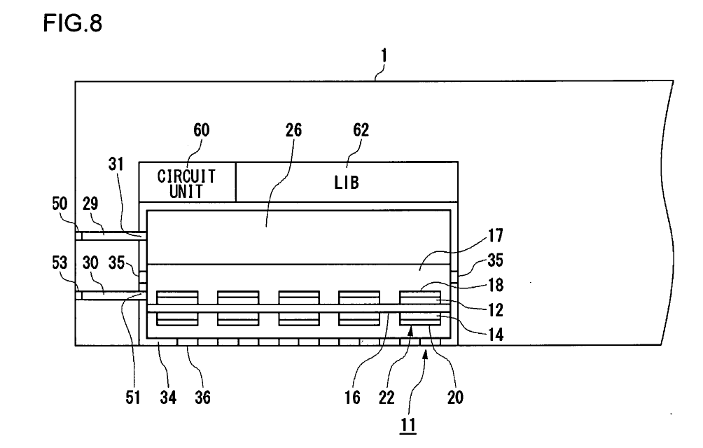

FIG. 8 shows a cellular phone 1 according to a fourth embodiment and the structure of a PEFC 11 installed in the cellular phone 1. In this embodiment, a hydrogen storage alloy tank which houses a hydrogen storage alloy is used as a fuel storage unit 26. The hydrogen storage alloy which can store hydrogen (for example, Mm (misch metal) Ni_{4.32}Mn_{0.18}Al_{0.1}Fe_{0.1}Co_{0.3} being a rare-earth system) is housed. The hydrogen storage alloy is not limited to the rare-earth system but may also include, for example, a Ti—Mn system, a Ti—Fe system, a Ti—Zr system, a Mg—Ni system, a Zr—Mn system, or the like. The hydrogen stored in the fuel storage unit 26, that is, the hydrogen storage alloy tank is supplied to a fuel charge unit 17 and is used for electrical power generation by the PEFC 11.

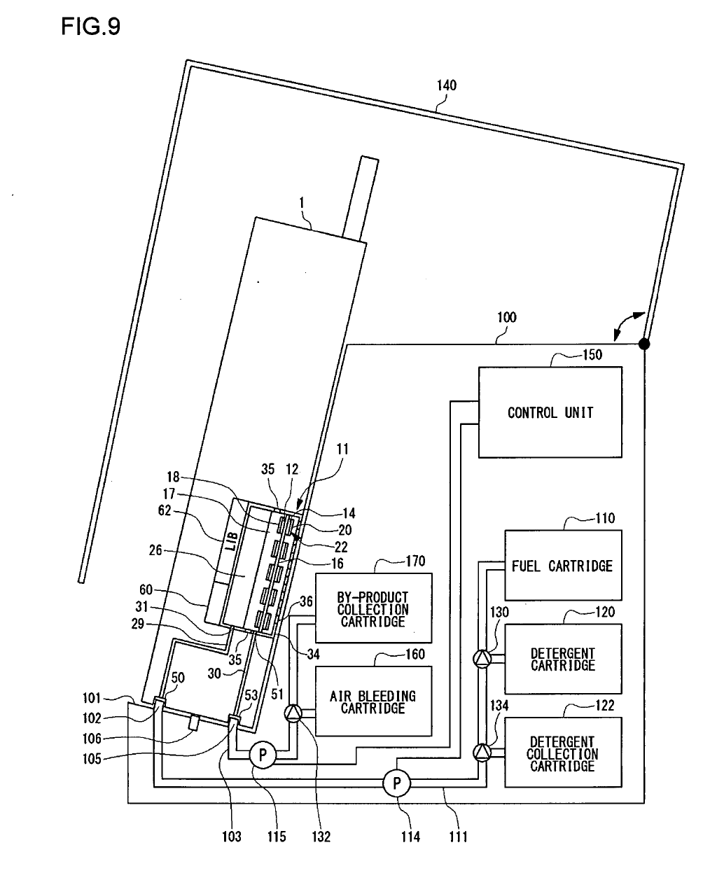

FIG. 9 shows the structure of a fuel supply device 100 for a fuel cell according to the fourth embodiment. As in the case of the third embodiment, the fuel supply device 100 for the fuel cell has an attachment unit 101 in which a fuel supply unit 102, a connection unit 105, and a pin 106 are provided so that the cellular phone 1 is attachable thereto.

The fuel supply device 100 for the fuel cell according to the present embodiment is provided with a fuel cartridge 110, a detergent cartridge 120, a detergent collection cartridge 122, an air bleeding cartridge 160, a by-product collection cartridge 170, a pump 114, a pump 115, and a control unit 150. The fuel cartridge 110, the air bleeding cartridge 160, and the by-product collection cartridge 170 are the identical to those of the third embodiment. In the detergent cartridge 120, the detergent stored may, for example, be an acid solution. The detergent collection cartridge 122 is switchably connected to a pipe 111 by a motor-operated three-way valve 134.

The pump 114 according to this embodiment functions as a fuel delivery unit, a detergent delivery unit, and a detergent sucking unit in accordance with the switching of the motor-operated three-way valves 130 and 134. A fuel suction unit 50 and the fuel supply unit 102 are used as paths for both delivering and sucking the out detergent.

The supply of fuel to the fuel cell, the by-product collection, and the maintenance operation of the fuel cell by the fuel supply device 100 for the fuel cell in this embodiment will now be described. The fuel supply device 100 for the fuel cell can be switched among various operation modes such as (a) fuel replenishment only, (b) fuel replenishment after collecting any by-products, (c) fuel replenishment after air-bleeding, (d) fuel replenishment after a hydrogen storage alloy activation process, and the like. In this case, a user can set the fuel supply device 100 for the fuel cell to a desired operation mode by the use of a display unit and an operation unit included in the cellular phone 1. The following description describes a case where the user has selected mode (d) fuel replenishment after the hydrogen storage alloy activation process as an example.

First, when the user attaches the cellular phone 1 to the attachment unit 101, the fuel suction unit 50 provided in the cellular phone 1 is connected to the fuel supply unit 102 provided in the fuel supply device 100 for the fuel cell, and an outside connection port 53 provided in the cellular phone 1 is connected to the connection unit 105 provided in the fuel supply device 100 for the fuel cell. At this time, the attachment of the cellular phone 1 is detected by pushing the pin 106 in, and a detection signal is sent to the control unit 150. Also at this time, the control unit 150 fixes the cellular phone 1 in place by a lock mechanism (not shown) or the like so that the cellular phone 1 is not able to be detached from the attachment unit 101.

Then, the control unit 150 switches the motor-operated three-way valves 130 and 134 so that the detergent (acid solution) contained in the detergent cartridge 120 can be supplied to the fuel storage unit 26 of the PEFC 11 using the pump 114. After that, the pump 114 is activated to supply the detergent contained in the detergent cartridge 120 to the fuel storage unit 26 of the PEFC 11. The detergent supplied to the fuel storage unit 26, that is, the hydrogen storage alloy tank activates the hydrogen storage alloy.

After the lapse of a predetermined period of time, the control unit 150 switches the motor-operated three-way valves 130 and 134 so that the detergent used for activating the hydrogen storage alloy is sucked out using the pump 114 and is collected in the detergent collection cartridge 122. After that, the pump 114 is activated to collect the used detergent existing in the fuel storage unit 26 into the detergent collection cartridge 122. It is preferable that after the washing process undertaken by the detergent is completed, the hydrogen storage alloy is rinsed with water and then heated and dried in a vacuum. Accordingly, the fuel supply device 100 for the fuel cell is further provided with a cartridge for storing water, a heating unit such as a heater, a vacuum pump, and the like and appropriately switches for undertaking the operation thereof.

Then, after the motor-operated three-way valve 130 is switched so as to be connected to the fuel storage unit 26, only a predetermined amount of fuel is supplied, or fuel is supplied only for a predetermined period of time to the fuel storage unit 26 using the pump 114.

According to the operation described above, since the fuel is supplied to the fuel storage unit 26 after the hydrogen storage alloy housed in the fuel storage unit 26 is activated, it is possible to restrict any reduction in the amount of hydrogen stored in the fuel storage unit 26. As a result, it is possible to lengthen the operating time of the PEFC 11.

Air bleeding described in the third embodiment may be carried out concurrently with, before, or after the washing of the fuel storage unit 26 described above and concurrently with, before, or after the fuel supply to the fuel storage unit 26.

It is preferable that a valve is provided between the fuel storage unit 27 and the fuel charge unit 17 and that the valve is closed while the detergent activates the hydrogen storage alloy so that the detergent does not leak from the fuel storage unit 26 to the fuel charge unit 17.

In this embodiment, the detergent is supplied to the fuel storage unit 26, however a fluid other than the fuel may be supplied to the fuel storage unit 26 instead of the detergent and any by-products remaining in the fuel storage unit 26 may be collected by pushing the by-products out. Alternatively, instead of supplying the fluid, a pump or the like may suck any by-products remaining in the fuel storage unit 26 out in order to collect them.

The present invention is not limited to the foregoing embodiments and it is also possible to make various modifications in specifications and the like to such based on the knowledge of those skilled in the art. An embodiment with such a modification is included in the scope of the present invention.

In the first embodiment, for example, fuel is supplied and the liquid waste is collected using the pump 114, however a fuel delivery unit other than the pump 114 may be used instead. As shown in FIG. 5, for example, using pressure with which the pin 106 is pushed in when the cellular phone 1 is attached to the attachment unit 101, the predetermined amount of fuel may be supplied from the fuel cartridge 110 to the fuel storage unit 26 by increasing the air pressure in the fuel cartridge 110.

According to this way, since auxiliary equipment such as a pump is no longer necessary, the structure of the fuel supply device 100 for the fuel cell may be simplified. Therefore, it is possible to miniaturize the fuel supply device 100 for the fuel cell and reduce manufacturing costs.

In the third embodiment, a fluid other than the fuel may be supplied to the fuel storage unit 26 or to the reforming unit 27 and any by-products remaining in the fuel storage unit 26 or the reforming unit 27 may be pushed out and collected in the by-product collection cartridge 170. Alternatively, instead of supplying the fluid, a pump or the like may suck out and collect any by-products remaining in the fuel storage unit 26 or the reforming unit 27.

In the fourth embodiment, the acid wash activates the hydrogen storage alloy, however the activation of the hydrogen storage alloy is not limited to the acid washing. For example, a repetitive process of placing the alloy under vacuum, under heat, and the like can also activate the hydrogen storage alloy. Thus, a pressurizing unit for applying pressure to the hydrogen storage alloy tank using a hydrogen gas, a vacuum unit for exhausting air from the hydrogen storage alloy tank, and a heating unit for heating the hydrogen storage alloy tank may also be provided therein. There are a number of ways of providing the heating unit including (1) flowing heated gas, (2) forming a path connecting the fuel supply device 100 for the fuel cell and the fuel storage unit 26 out of a pipe with high thermal conductivity and heating it with a heater provided in the fuel supply device 100 for the fuel cell, (3) disposing a heater around the fuel storage unit 26 and heating the heater by electrical power from the fuel supply device 100 for the fuel cell, and the like. In particular, when LaNi₅ is used as the hydrogen storage alloy, the hydrogen storage alloy tank needs to be heated to slightly higher than 100 degrees centigrade in order to initiate the activation process.

Each of the foregoing embodiments discusses a case where there is no exhaust port to the outside in an example of an anode (in the vicinity of the fuel storage unit, the fuel charge unit, and the anode electrodes), but there may be the exhaust port included in the vicinity thereof.

Each of the foregoing embodiments uses the cellular phone as an example of a portable device in which the fuel cell is installed. However, the portable device may be a digital camera, a PDA, an MP3 player, a portable game machine, and the like.

What is claimed is:

1. A fuel supply device for a fuel cell which can supply fuel to the fuel cell, comprising:
an attachment unit to which the fuel cell is attachable;
a fuel cartridge which houses fuel used in the fuel cell;
a residual material collecting means which collects residual materials remaining in the fuel cell when the fuel cell is attached to the attachment unit; and
a fuel supply unit which supplies the fuel from the fuel cartridge to a fuel storage unit of the fuel cell when the fuel cell is attached to the attachment unit.

2. The fuel supply device according to claim 1, wherein the residual material collecting means collects liquid waste as residual materials.

3. The fuel supply device for a fuel cell according to claim 2, wherein the residual material collecting means collects the liquid waste by supplying fuel to the fuel storage unit and pushing out the liquid waste remaining in the fuel storage unit.

4. The fuel supply device for a fuel cell according to claim 3, wherein the fuel supply unit supplies a predetermined amount of fuel to the fuel storage unit after the fuel storage unit becomes full of fuel.

5. The fuel supply device for a fuel cell according to claim 2, further comprising:
a detergent cartridge which houses detergent;
a detergent supply unit which supplies the detergent to the fuel storage unit to wash an anode electrode of the fuel cell; and
a detergent collection unit which collects the detergent from the fuel storage unit.

6. The fuel supply device for a fuel cell according to claim 5, further comprising a switching unit which switches between the fuel supply to the fuel storage unit and the liquid waste collection, and the detergent supply to the fuel storage unit and the detergent collection.

7. A fuel cell which is attachable to the attachment unit of the fuel supply device for a fuel cell according to claim 2, comprising:
a fuel supply port through which the fuel supply unit supplies fuel to the fuel storage unit for storing fuel; and
a liquid waste discharge port through which the liquid waste is discharged.

8. The fuel supply device for a fuel cell according to claim 1, wherein the residual material collecting means collects by-products as residual materials.

9. The fuel supply device for a fuel cell according to claim 8, wherein the residual material collecting means supplies a fluid other than the fuel to a fuel charge unit in which fuel supplied from the fuel storage unit is charged, and collects the by-product remaining in the fuel charge unit and the anode electrode by pushing out the by-product.

10. The fuel supply device for the fuel cell according to claim 8, wherein the residual material collecting means collects the by-product remaining in a fuel charge unit in which fuel supplied from the fuel storage unit is charged and the anode electrode by sucking up the by-product.

11. The fuel supply device for the fuel cell according to claim 8, wherein the residual material collecting means collects by-product remaining in the fuel storage unit or a reforming unit in which the fuel supplied from the fuel storage unit is reformed by supplying a fluid other than the fuel to the fuel storage unit or the reforming unit and by pushing out the by-product.

12. The fuel supply device for the fuel cell according to claim 8, wherein the residual material collecting means collects by-product remaining in the fuel storage unit or a reforming unit in which the fuel supplied from the fuel storage unit is reformed by sucking up the by-product.

13. The fuel supply device for the fuel cell according to claim 8, further comprising a unit for applying a load on the fuel cell to which a fluid other than the fuel is supplied in a state where the fuel cell is attached to the attachment unit and the fluid is supplied to the fuel cell.

14. A fuel cell which is attachable to the attachment unit of the fuel supply device for a fuel cell according to claim 8, comprising:
a fuel storage unit connection port which connects to the fuel storage unit through which the fuel or a fluid other than the fuel is supplied and any by-products remaining in the fuel storage unit are discharged; and
a fuel charge unit connection port connecting to a fuel charge unit in which the fuel supplied from the fuel storage unit is charged into in order to supply the fuel or the fluid other than the fuel and discharge any by-products remaining in the fuel charge unit or at the anode electrode.
